(19) United States
(12) Patent Application Publication
(10) Pub. No.: US 2016/0124776 A1
(43) Pub. Date: May 5, 2016

(54) PROCESS FOR CONTROLLING A PROCESSING UNIT IMPROVING THE MANAGEMENT OF THE TASKS TO BE EXECUTED, AND CORRESPONDING PROCESSING UNIT

(71) Applicant: STMICROELECTRONICS (ROUSSET) SAS, Rousset (FR)

(72) Inventor: Christophe ARNAL, Saint Vallier de Thiey (FR)

(21) Appl. No.: 14/840,208

(22) Filed: Aug. 31, 2015

(30) Foreign Application Priority Data
Oct. 30, 2014 (FR) 1460431

(51) Int. Cl. G06F 9/50; G06F 13/24

(52) U.S. Cl. CPC G06F 9/5038; G06F 13/24

(57) ABSTRACT

A process controls a processing unit in the presence of a task being executed by the processing unit. The processing unit includes at least one external input electrically connected to a corresponding output of the processing unit, and is associated with a level of priority of execution. The process includes, in the presence of an auxiliary-task request generated internally within the processing unit, generation by the processing unit of an auxiliary electrical signal corresponding to the request for execution of the auxiliary task. The auxiliary electrical signal is relayed to the at least one external input. A comparison is made between the priority levels respectively associated with the at least one external input and with the task being executed.

### FIELD OF THE INVENTION

The present disclosure relates to management of the tasks of a processing unit, and more particularly, to a process for controlling a processing unit scheduling execution of the tasks by the microprocessor while taking into account the priority levels of the tasks.

### BACKGROUND

A processing unit, such as a microprocessor, carries out various tasks, the execution of which may be initially requested by an element external to the microprocessor or by the microprocessor itself. A task that is capable of being executed by a microprocessor may entail a level of priority. The assignment of priority levels to each task to be executed enables the level of importance of each task, and the order in which these tasks should preferably be executed, to be defined.

In order to organize execution of the tasks, i.e., in order to schedule the tasks of the processing unit, the processing unit generally uses task-scheduling means, also called a scheduler.

The task-scheduling means enable access to the resources of the processing unit to be controlled for execution of the various tasks. The task-scheduling means enable allocation of the resources of the processing unit to the various tasks. One of the roles of the scheduler is therefore to enable all the tasks to be executed at one moment or another and to use the processor optimally for the user.

A scheduler is principally characterized by the rate of execution of the tasks, the latency period at the time of a change of task, and the size of the memory that is necessary for execution of all the executable tasks and the management of the memory. The memory may be external if the processing unit is a processor or internal in other cases.

Two types of schedulers are known which are generally utilized in a processing unit. The first type of task-scheduling means include a software scheduler that does not take into account the priority levels of the tasks for which an execution request is issued, in comparison with the task in the course of execution. In the first type of scheduler the task in the course of execution has to be completed before another task can be executed. No interruption of a task is taken into account.

The second type of task-scheduling means include a scheduler that is put into effect by a software implementation within an operating system executed by the microprocessor. In order that each task is executed without being concerned about the others, and/or also in order to execute the tasks in accordance with the constraints imposed on the system, the scheduler of the system brings about context switches of the system.

However, the context switching adds latency to the operation. The latency is due, in particular, to execution time of the software scheduler and to the saving/restoration of the context of the tasks. In fact, each time a task-execution request is received by the microprocessor, the microprocessor implements, via a computer program, a comparison of the priority levels of the task in the course of execution and of the tasks for which an execution request has been issued. This data-processing verification is time-consuming.

Furthermore, implementation of the scheduler within the operating system is relatively complex. In particular, a plurality of memory-area pointers are utilized, and this necessitates the need for a sizeable memory.

In fact, in this type of scheduler a distinct memory space is allotted for execution of each task. The interruption of a task brings about the saving of its context in its allotted memory space and execution of another task in another distinct memory space. This entails the necessity of providing a supplementary memory margin for each distinct memory space, and therefore, an increase in the size of the memory is needed.

### SUMMARY

According to one embodiment and mode of implementation, a process and an architecture for controlling a processing unit may enable a more efficient scheduler to be provided, taking into account priority levels of the tasks to be executed and enabling a latency period at the time of interruption of a task to be reduced.

According to one aspect, a process may control a processing unit in the presence of a task in the course of execution by the processing unit.

According to a general characteristic of this aspect, the processing unit may be equipped with at least one external input electrically connected to a corresponding output of the processing unit. The at least one external input may be associated with a level of priority of execution. The process may comprise, in the presence of an auxiliary-task request generated internally within the processing unit, a generation by the processing unit of an auxiliary electrical signal corresponding to the request for execution of the auxiliary task. The auxiliary electrical signal may be relayed to the at least one external input. A comparison may be made between the priority level respectively associated with the at least one external input and with the task in the course of execution.

Generation by the processing unit of an auxiliary electrical signal to be relayed to an external input may enable each of the task-execution requests to be received at the input of the processing unit. This may enable all the requests to be processed in the same way, like interrupts. The comparison of the priority levels may advantageously be made directly via the cabling of the processing unit and of the various external inputs, whatever they may be.

The architecture of the processing unit, enabling the implementation of such a process, therefore enables each task to be managed by the interrupt handler of the processing unit. The comparison may enable the task possessing with the highest priority, i.e., the one for which the associated task has to be performed before the others, to be determined among the tasks for which an execution request has been received and the task in the course of execution. The comparison may enable a determination of whether the task in the course of execution has to be interrupted in favor of a task possessing a more important priority level.

Advantageously, the processing unit may include at least one supplementary external input for receiving an electrical signal corresponding to a request, generated outside or external the processing unit, for execution of at least one task by the processing unit. The process may include a comparison between the priory levels respectively associated with the at least one supplementary external input, with the at least one external input, and with the task in the course of execution.

In this configuration the task-execution requests generated by an external component may also be taken into account in the same way as the requests for execution of auxiliary tasks generated internally.

According to the result of the comparison, the process may include, in addition, an interruption of the additional task in the course of execution and a saving of its parameters if one of the tasks associated with the at least one external input or with the at least one auxiliary external input possesses, in comparison with the additional task in the course of execution, a priority level activating execution of this task. The priority level, for example, may be a higher priority level than the additional task in the course of execution.

According to the protocol being implemented, a new task having a priority level on the same level or on a lower level than the task in the course of execution may bring about an interruption and saving of the task in the course of execution.

The comparison may be faster than a comparison made by a software implementation, by virtue of the electrical architecture wherein the cabling allows for making an electrical comparison rather than a comparison implemented by data processing in an operating system.

Moreover, the comparison may not bring about a verification of the priority levels on each occurrence, as in the case of an operating system. This is because the processing unit already knows, by virtue of the priorities associated with each external input, supplementary or not, for which external inputs, supplementary or not, receiving a task-execution request it will have to interrupt the task in the course of execution.

The comparison is also faster than in a system including a straightforward electronic scheduler as known in the art, because the latter is managed by the processing unit over a large number of clock cycles. The clock cycles may generally be on the order of about a hundred. In the process implemented in this aspect it might be done, by way of a non-limiting example, by the writing of a single bit, via an external input, supplementary or not, in the processing unit to request a task. According to the bit the processing unit may know directly what it has to do. The cabling and the priority levels assigned to each external input, supplementary or not, may be given, which may be pre-registered in the processing unit.

The saving of the parameters of the interrupted task may enable the context of the interrupted task to be saved to enable the subsequent resumption of the interrupted task.

The task associated with the at least one external input or with the at least one supplementary external input possessing a higher priority level than the additional task in the course of execution may preferably be executed following the saving of the additional task.

By executing the new task following the saving of the context of the interrupted task, no memory space is lost. In fact, no memory space is unused or kept unusable for the fulfillment of the tasks by the processing unit.

At least one memory space may preferably be dedicated to execution of the tasks by the processing unit, and a portion of memory space used by a completed task may be capable of being used for execution of a possible other task to be executed.

When a task is completed and no new task possesses a higher priority level than that of the last interrupted task, the memory pointer may go up again to the memory address at which the parameters of the last interrupted task have been saved. The parameters may be restored from this address, and the task may subsequently be resumed.

Advantageously, the saving of the additional task may comprise solely the saving of the work registers of the processing unit. Saving solely the work registers of the processing unit may enable a reduction in the number of parameters to be saved for saving the context of the interrupted task, and thus may enable the latency period to be reduced.

According to another aspect, a processing unit may include at least one external input electrically connected to a corresponding output of the processing unit and associated with a level of priority of execution. The processing unit may include, in addition, generating means or a generating module configured to generate, in the course of execution of a task by the processing unit, an auxiliary electrical signal corresponding to the request. The auxiliary electrical signal may be generated internally within the processing unit for execution of an auxiliary task by the processing unit. The generating means may be coupled via the corresponding output to the at least one external input. The processing unit may include, in addition, comparison means or a comparison module for comparing the priority levels respectively associated with the at least one external input and with the task in the course of execution.

The generating means may preferentially be coupled to the at least one external input by at least one physical link. The term physical link is understood to mean electrically conductive tracks, or electrical cables, or any kind of electrical connection.

The processing unit may preferably include at least one supplementary external physical input that may receive an electrical signal corresponding to a request, generated outside or external the processing unit. The electrical signal may be for execution of a task by the processing unit. The comparison means may be configured, in addition, to make a comparison between the priority levels respectively associated with the at least one supplementary external input, with the at least one external input, and with the task in the course of execution.

The processing unit may advantageously include, in addition, interrupt means or an interrupt module configured to interrupt the additional task in the course of execution, and saving means or a saving module configured to register parameters of the interrupted task. The interrupt means and the saving means may be actuated if one of the tasks associated with the at least one supplementary external input or with the at least one external input possesses, in comparison with the additional task in the course of execution, a priority level activating execution of this task. The priority level may be, for example, a higher priority level than the additional task in the course of execution.

The processing unit may preferably include at least one memory space dedicated to execution of the tasks by the processing unit, and a unique memory-space pointer.. A new task may be executed following the saving of the parameters of the interrupted task. The space used in a memory space for a completed task may be capable of being used by any other task to be executed. The saving means may advantageously be configured to save solely the work registers of the processing unit.

### BRIEF DESCRIPTION OF THE DRAWINGS

Other advantages and characteristics of the invention will become apparent from an examination of the detailed description of an embodiment of the invention, which is not at all limiting, and of the attached drawings, in which:

FIG. 1 represents schematically a processing unit according to an embodiment of the invention; and

FIG. 2 presents a flow chart of the process for controlling the processing unit shown in FIG. 1, according to an embodiment of the invention.

### DETAILED DESCRIPTION

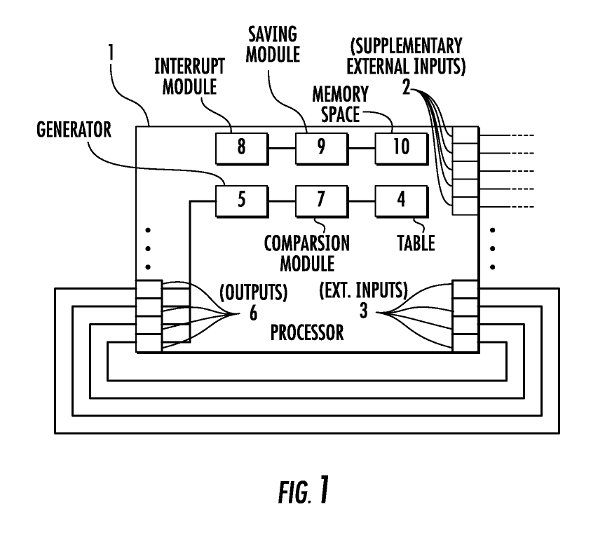

In FIG. 1 a processing unit according to an embodiment of the invention is represented schematically. The processing unit represented in FIG. 1 is a microprocessor 1. The microprocessor 1 is equipped with a plurality of external inputs 3 intended to receive distinct electrical signals generated by the microprocessor 1. Each external input corresponds to a request for execution by the microprocessor 1 of a distinct auxiliary task.

The microprocessor 1 includes, in addition, a plurality of supplementary external physical inputs 2 each capable of receiving a distinct electrical signal. Each distinct electrical signal is generated outside or external the microprocessor 1 and corresponds to a request for execution by the microprocessor 1 of a corresponding distinct task.

The supplementary external inputs 2 and the external inputs 3 are physical inputs of the microprocessor and are each associated, in the example illustrated, with different levels of priority of execution with the aid of a table 4 recording the priority levels for each supplementary external input 2 and external input 3. The correspondence table 4 may be stored in a memory initially parametrized with the various priority levels.

The microprocessor 1 also includes generating means or a generating module 5 configured to generate an auxiliary electrical signal corresponding to the request, generated internally within the microprocessor 1, for execution of an auxiliary task. The generating means 5 are connected to each external input 3 via a corresponding output 6 of the microprocessor 1. The generating means 5 may be software configured to control generation of an electrical signal at one of the outputs 6 of the microprocessor 1.

The microprocessor 1 includes, in addition, comparison means or a comparison module 7 for comparing the priority levels respectively associated with the supplementary external inputs 2 and with the external inputs 3 having respectively received an electrical signal. The comparison means 7 may be implemented by electronic components, such as with a set of logic gates, configured to select the signal having the highest priority.

The generating means 5 for generating the auxiliary electrical signal are configured to enable generation of a request for execution of a task in the course of execution of an additional task by the microprocessor 1. In addition, the comparison means 7 are configured to make a comparison between the priority levels respectively associated with the supplementary external inputs 2 and with the external inputs 3 having respectively received an electrical signal, and with the task in the course of execution.

The microprocessor 1 is also equipped with interrupt means or an interrupt module 8 for interruption of the additional task in the course of execution, with saving means or a saving module 9 for saving the parameters of the interrupted task. Memory space 10 is dedicated to execution of the tasks by the microprocessor 1. The interrupt means 8 and the saving means 9 are configured to act if one of the tasks associated with the supplementary external inputs 2 or with the external inputs 3 having received an electrical signal possesses a higher priority level than the additional task in the course of execution.

The interrupt means 8 may be implemented in software or in the form of electronic control means or an electronic controller, and the saving means 9 may be realized in the form of an electronic control module.

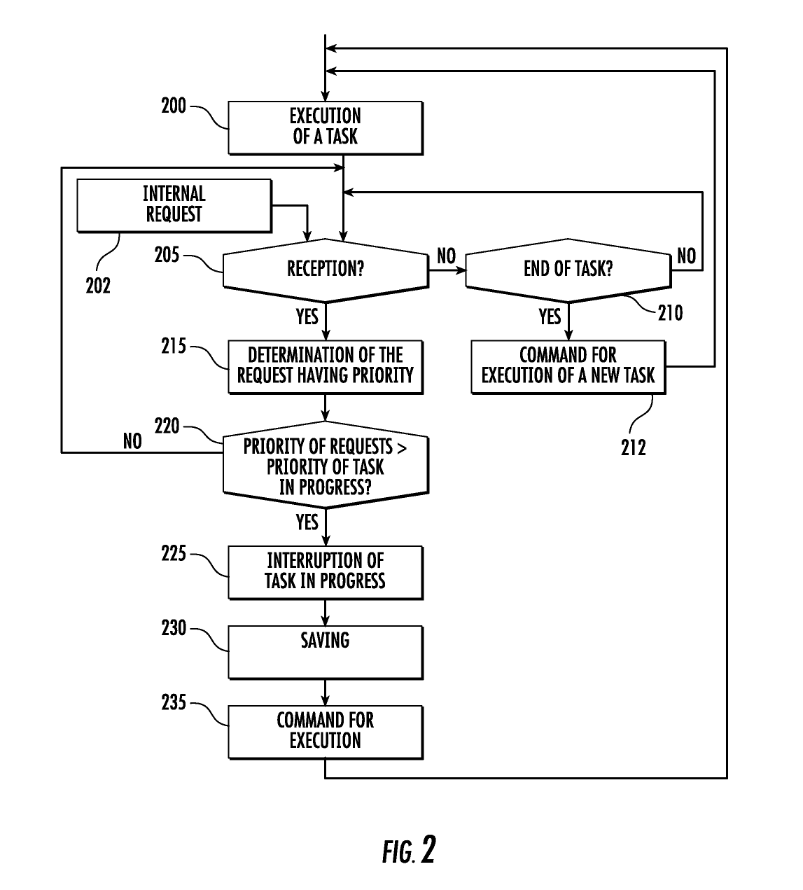

Operation of the microprocessor 1 is governed by the process illustrated in FIG. 2, which illustrates a flow chart of a control process according to an embodiment of the invention. In a first step 200 the microprocessor 1 executes a task. The task in the course of execution may be a task, the request for which has been generated by an element external to the microprocessor 1.

In step 202 the microprocessor 1 can generate, in the course of execution of the task in step 200, an internal request for execution, by itself, of an auxiliary task. If the microprocessor 1 generates internally a request for execution of an auxiliary task, the generating means 5 relay an auxiliary electrical signal to an external input 3 via one of the outputs 6. The electrical signal relayed in this way corresponds to a request for execution of the auxiliary task.

In a step 205 it is verified whether a request for execution of a new task has been received. The request may have possibly been issued by an entity external to the microprocessor 1 or else internally by the microprocessor 1 in step 202.

If no new request has been received, in step 210 it is verified whether the task in the course of execution is completed. If the task is completed, step 212 is execution of a new task that is controlled as a function of the priority levels of the tasks waiting for execution. The process resumes in step 200.

When the microprocessor 1 receives, in step 205, a request for execution of a new task, it compares in step 220 the priority level associated with the new task, the request for execution of which has just been received, with the priority level of the task in the course of execution.

In the case where several requests for execution are received at the same time in step 205, before step 220 the microprocessor 1 compares, in step 215, the priority levels of all the requests received. The comparison may, in particular, comprise a comparison of the priority level of a request for execution of an auxiliary task with the priority level of a request, generated by an element external to the microprocessor 1, for execution of a task.

The comparison in step 215 results in the designation of a request possessing the highest priority level. The priority level of this request will then be compared with the priority level of the task in the course of execution in step 220.

Alternatively, steps 215 and 200 may be combined into a single step in which a comparison is made between the priority levels respectively associated with the supplementary external inputs 2 and with the external inputs 3 having respectively received an electrical signal, and with the task in the course of execution.

If, at the time of the comparison in step 220, the priority level of the new task, the execution of which is requested, possesses a lower priority than that of the task in the course of execution, the execution of the task already in the course of execution is maintained. In step 205 the wait is resumed for a new reception of a task-execution request or the end of the task in the course of execution.

If the priority level of the new task, the execution of which is requested, possesses a higher priority than that of the task in the course of execution, the task in the course of execution is interrupted in step 225 by the interrupt means 8. In step 230 the parameters of the interrupted task are saved in the memory 10 by the saving means 9.

The saving comprises solely the saving of the work or operating registers of the microprocessor 1 so as to reduce the registering time and thus the latency period of the microprocessor 1 between the interruption 225 and execution of the new task.

The saving solely of the work registers of the processing unit enables a reduction in the number Of parameters to be saved for saving the context of the interrupted task, and thus enables the latency period to be reduced.

Then, in step 235, the control means issue a command for execution of the new task, and the process resumes at the first step 200. The new task being executed in the memory space 10 directly follows the saving of the parameters of the last interrupted task.

The microprocessor 1 may also understand the registering of the priority level of the task in the course of execution as an interrupt threshold and thus configure itself automatically in order to enable an interruption of the task in the course of execution only if some of the supplementary external inputs 2 or some of the external inputs 3 receive an electrical signal.

The architecture of the microprocessor and the associated process implemented within the microprocessor enable an optimized scheduler to be obtained, taking into account the priority levels of the tasks to be executed and enabling the latency period to be reduced at the time of the interruption of a task. This is based on evaluating the priority levels via the wiring of the circuit.

1-12. (canceled)

13. A process for controlling a processing unit when a task is being executed by the processing unit, with the task being executed having a priority level of execution, with the processing unit comprising at least one output and at least one external input connected to the at least one output, and with the at least one external input being associated with a priority level of execution, the process comprising:
generating by the processing unit an auxiliary signal corresponding to an auxiliary-task request generated internally within the processing unit;
relaying the auxiliary signal to the at least one external input; and
comparing the priority level of execution associated with the at least one external input with the priority level of execution of the task being executed while the task is being executed.

14. The process according to claim 13, wherein the processing unit comprises at least one supplementary external input configured to receive a supplemental signal corresponding to a request for execution of at least one additional task by the processing unit, with the at least one supplemental external input having a priority level of execution associated therewith, and with the supplemental signal being generated external the processing unit, the comparing further comprising:
comparing the priority levels of execution associated with the at least one supplementary external input, the at least one external input, and the task being executed while the task is being executed.

15. The process according to claim 14, further comprising:
interrupting the task being executed if one of the priority levels of execution associated with the at least one supplementary external input and the at least one external input is higher than the priority level of execution of the task being executed; and
saving parameters of the interrupted task.

16. The process according to claim 15, wherein after saving the parameters of the interrupted task, further comprising executing a task associated with the at least one supplementary external input or a task associated with the at least one external input having the highest priority level of execution.

17. The process according to claim 16, wherein the processing unit comprises at least one memory space dedicated to execution of the tasks by the processing unit, and a portion of the at least one memory space used by a completed task is used for execution of a next task to be executed.

18. The process according to claim 15, wherein the processing unit further comprises at least one working register used for executing the task, and wherein saving the parameters comprises saving the parameters in the at least one working register when the task is interrupted.

19. A process for controlling a processing unit comprising at least one output and at least one external input connected to the at least one output, and at least one supplementary external input, the process comprising:
operating the processing unit to execute a task, with the task being executed having a priority level of execution, and with the at least one external input being associated with a priority level of execution;
generating by the processing unit an auxiliary signal corresponding to an auxiliary-task request generated internally within the processing unit;
relaying the auxiliary signal to the at least one external input;
operating the processing unit to receive a supplemental signal on the at least one supplementary external input for execution of at least one additional task by the processing unit, with the at least one supplemental external input having a priority level of execution associated therewith;
comparing the priority levels of execution associated with the at least one supplementary external input, the at least one external input, and the task being executed while the task is being executed.

20. The process according to claim 19, further comprising:
interrupting the task being executed if one of the priority levels of execution associated with the at least one supplementary external input and the at least one external input is higher than the priority level of execution of the task being executed; and
saving parameters of the interrupted task.

21. The process according to claim 20, wherein after saving the parameters of the interrupted task, further comprising executing a task associated with the at least one supplementary external input or a task associated with the at least one external input having the highest priority level of execution.

22. The process according to claim 21, wherein the processing unit comprises at least one memory space dedicated to execution of the tasks by the processing unit, and a portion of the at least one memory space used by a completed task is used for execution of a next task to be executed.

23. The process according to claim 21, wherein the processing unit further comprises at least one working register used for executing the task, and wherein saving the parameters comprises saving the parameters in the at least one working register when the task is interrupted.

24. A processing unit comprising:
at least one output;
at least one external input coupled to said at least one output, with said at least one external input having a priority level of execution associated therewith;
a generating module coupled to said at last one external input via said at least one output, and configured to generate, while a task is being executed by the processing unit, an auxiliary signal corresponding to an auxiliary request for execution of an auxiliary task by the processing unit; and
a comparison module configured to compare the priority level of execution associated with said at least one external input with the task being executed during execution of the task.

25. The processing unit according to claim 24, further comprising at least one physical link extending between said at least one output and said at least one external input.

26. The processing unit according to claim 24, further comprising:
at least one supplementary external input configured to receive a supplemental signal corresponding to a request for execution of at least one additional task by the processing unit, with the at least one supplemental external input having a priority level of execution associated therewith, and with the supplemental signal being generated external the processing unit;
said comparison module further configured to compare the priority levels of execution associated with the at least one supplementary external input, the at least one external input, and the task being executed while the task is being executed.

27. The processing unit according to claim 26, further comprising:
an interrupt module configured to interrupt the task being executed if one of the priority levels of execution associated with the at least one supplementary external input and the at least one external input is higher than the priority level of execution of the task being executed; and
a saving module configured to save parameters of the interrupted task.

28. The processing unit according to claim 27, further comprising:
at least one memory space dedicated to execution of the tasks by the processing unit; and
a memory-space pointer for said at least one memory space;
with a portion of said at least one memory space used by a completed task is used for execution of a next task to be executed.

29. The processing unit according to claim 27, further comprising at least one working register used for executing the task, and wherein saving the parameters comprises saving the parameters in the at least one working register when the task is interrupted.
